(19) United States
(12) Patent Application Publication
(10) Pub. No.: US 2010/0060582 A1
(43) Pub. Date: Mar. 11, 2010

(54) Cradle, mouse and mouse unit

(75) Inventors: Jun Ikegami, Nagano (JP); Masao Ozawa, Ibaraki (JP); Takahiko Maehata, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/584,021

(22) Filed: Aug. 28, 2009

(30) Foreign Application Priority Data
Sep. 8, 2008 (JP) P2008-229566

(51) Int. Cl. G06F 3/033; F16M 11/04

(52) U.S. Cl. 345/163; 248/176.1

(57) ABSTRACT

A cradle of the present invention includes a support portion and a holding portion that is formed on the support portion as a depression with a shape corresponding to part of a mouse. The holding portion of the cradle includes an inclined surface that is a flat surface over which a mouse can be slid and that has a predetermined angle with respect to a bottom surface of the support portion, and a guiding edge portion that is formed on at least a lower portion and a side portion of an outer edge of the inclined surface and that guides the mouse that is slid along the inclined surface to a holding position.

### BACKGROUND OF THE INVENTION

1. Field of the Invention

The present invention relates to a cradle, a mouse and a mouse unit. More specifically, the present invention relates to a cradle that charges a mouse, a mouse that is charged, and a mouse unit that includes the cradle and the mouse.

2. Description of the Related Art

Input devices for a personal computer etc. include a keyboard to perform input of characters and numerals, for example, and a pointing device that manipulates a display position of a cursor displayed on a display screen. Pointing devices include, for example, a mouse, a trackball, a touch pad or the like, of which the mouse is widely used due to its high level of operational ease.

In known art, a mouse is used when connected to a personal computer by a cable etc., but sometimes the cable obstructs operation of the mouse. For that reason, in recent years, wireless mouse devices are becoming widespread that can be used wirelessly by communicating using radio waves or infrared rays etc. with a reception device connected to a personal computer etc. When a wireless mouse is used, a battery is mounted in the mouse itself to supply power to transmit operation information and positional information of the mouse.

However, if the battery runs out, it is no longer possible to operate the mouse, and the battery has to be frequently replaced. In particular, when the mouse is an optical mouse, in which a light emitting portion and a light receiving portion are provided in a bottom surface of the mouse and movement distance and direction, speed etc. are detected optically, the amount of power consumed by the light emitting portion in comparison to a ball type mouse is larger, resulting in an even greater frequency of battery replacement. Here, a mouse is proposed in which a rechargeable secondary battery is mounted, and the secondary battery can be charged by a mouse charger that is capable of charging the secondary battery without removing the secondary battery from the mouse. (Refer to, for example, Japanese Patent Application Publication No. JP-A-2008-15693 and Japanese Patent Application Publication No. JP-A-2005-259102.

### SUMMARY OF THE INVENTION

However, in Japanese Patent Application Publication No. JP-A-2008-15693 and Japanese Patent Application Publication No. JP-A-2005-259102, to charge the secondary battery mounted in the mouse, it is necessary to insert the mouse into a plug socket or connect it to a charging unit and so on, and the mouse is not able to easily be charged.

To address this, the present invention provides a new and improved cradle, mouse and mouse unit that allow the mouse to be easily held.

According to an embodiment of the present invention, there is provided a cradle including a support portion and a holding portion that is formed on the support portion as a depression with a shape corresponding to part of a mouse. The holding portion of the cradle includes: an inclined surface that is a flat surface over which a mouse can be slid and that has a predetermined angle with respect to a bottom surface of the support portion; and a guiding edge portion that is formed on at least a lower portion and a side portion of an outer edge of the inclined surface and that guides a mouse that is slid along the inclined surface to a holding position.

According to the present invention, when causing a mouse to be held in the holding portion of the cradle, a user slides the mouse along the inclined surface of the cradle and moves it to a holding position. At that time, by the inclined surface of the cradle having a predetermined angle, it is easy to slide the mouse along the inclined surface. Further, by providing the guiding edge portion on at least a lower portion and a side portion of an outer edge of the inclined surface, the mouse that is slid along the inclined surface can be guided to the holding position. In this way, the mouse moves naturally to the holding position, and the mouse can easily be caused to be held in the cradle.

The guiding edge portion can be formed in a shape that removes foreign material that is placed on the inclined surface from the holding position. Furthermore, the guiding edge portion can be formed, for example, as a general U shape along the outer edge of the inclined surface, and can also be formed having a concavely curved surface in an upward direction from the outer edge of the inclined surface.

In addition, the holding portion can include a hook portion, provided on an upper portion of the outer edge of the inclined surface, that latches a mouse in the holding position. The hook portion is, for example, a protrusion that protrudes from the inclined surface and an outer edge of the hook portion is formed as a general R shape.

Additionally, a primary coil that causes generation of a magnetic force to perform non-contact charging of a mouse can be provided inside the cradle in a position facing the inclined surface. Further, the predetermined angle can be an angle in a range between 45 degrees and 60 degrees.

According to another embodiment of the present invention, there is provided a mouse including a housing that includes: a lower member formed of a bottom surface and a curved surface that is formed on an outer edge of the bottom surface; an upper member provided with an operating portion that is used to perform an input operation; and a side member that couples the lower member and the upper member, and a detection portion provided inside the housing that detects a position and operation of the mouse itself. A slit that engages with a hook portion of the cradle holding the mouse is formed in a bottom surface of the housing.

Here, an inclined guiding surface that guides the mouse to the hook portion of the cradle can be formed on the slit. Further, the slit can be provided in a battery cover that covers a battery housing portion housing a battery supplying electric power and that is openable/closable with respect to the housing.

According to another embodiment of the present invention, there is provided a mouse unit including a mouse and a cradle that holds the mouse. The mouse includes a housing including: a lower member that is formed of a bottom surface and a curved surface formed on an outer edge of the bottom surface, part of the lower member fitting with a support portion of the cradle; an upper member provided with an operating portion that is used to perform an input operation; and a side member that couples the lower member and the upper member. The cradle includes a support portion, and a holding portion that is formed on the support portion as a depression with a shape corresponding to part of the mouse. The holding portion includes an inclined surface that is a flat surface over which the mouse can be slid and that has a predetermined angle with respect to a bottom surface of the support portion, and a guiding edge portion that is formed on at least a lower portion and a side portion of an outer edge of the inclined surface and that guides the mouse that is slid along the inclined surface to a holding position.

The holding portion of the cradle can include a hook portion, provided on an upper portion of the outer edge of the inclined surface, that latches the mouse in the holding position. At that time, a slit that engages with the hook portion of the cradle in the holding position may also be formed in a bottom surface of the housing of the mouse.

Furthermore, a primary coil that causes generation of a magnetic force to perform non-contact charging of the mouse can be provided inside the cradle in a position facing the inclined surface. Meanwhile, a secondary coil that generates an electric, current by the magnetic force generated by the primary coil of the cradle can be provided inside the housing of the mouse such that the secondary coil faces the bottom surface. In this case, each of the coils is positioned such that the primary coil of the cradle and the secondary coil of the mouse face each other when the mouse is being held by the cradle in the holding position.

In addition, the mouse unit can be structured such that, when the mouse is being held by the cradle in the holding position, a surface on a back surface side of the side member of the mouse and a surface on a front surface side of the support member of the cradle are generally perpendicular to the bottom surface of the cradle and are generally flush with each other.

According to the embodiments of the present invention, a cradle that can easily hold a mouse, a mouse and a mouse unit can be provided.

### BRIEF DESCRIPTION OF THE DRAWINGS

FIG. 1 is a perspective view showing a mouse unit according to an embodiment of the present invention in a disengaged state;

FIG. 2 is a perspective view showing the mouse unit according to the present embodiment in a state in which a mouse is being caused to be held in a cradle;

FIG. 3 is a perspective view showing the mouse unit according to the present embodiment in a state in which the mouse is set in the cradle;

FIG. 4 is a plan view showing the mouse according to the present embodiment;

FIG. 5 is a bottom view showing the mouse according to the present embodiment;

FIG. 6 is a cross-section view showing a cross section of the mouse unit shown in FIG. 3;

FIG. 7 is a perspective view showing a battery cover of the mouse according to the present embodiment in an open state;

FIG. 8 is a perspective view showing a state in which the battery is being removed from the mouse according to the present embodiment;

FIG. 9 is a front view showing the cradle according to the present embodiment;

FIG. 10 is a perspective view showing the cradle according to the present embodiment;

FIG. 11 is a perspective view of the mouse unit according to the present embodiment as seen from the front, in a state in which the mouse is being caused to be held by the cradle.

FIG. 12 is an enlarged partial view showing a mouse slit and a cradle hook portion in an engaged state; and

FIG. 13 is an explanatory diagram illustrating a shape of an inclined surface and a guiding edge portion of the cradle.

### DETAILED DESCRIPTION OF THE INVENTION

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### Outline Structure of Mouse Unit

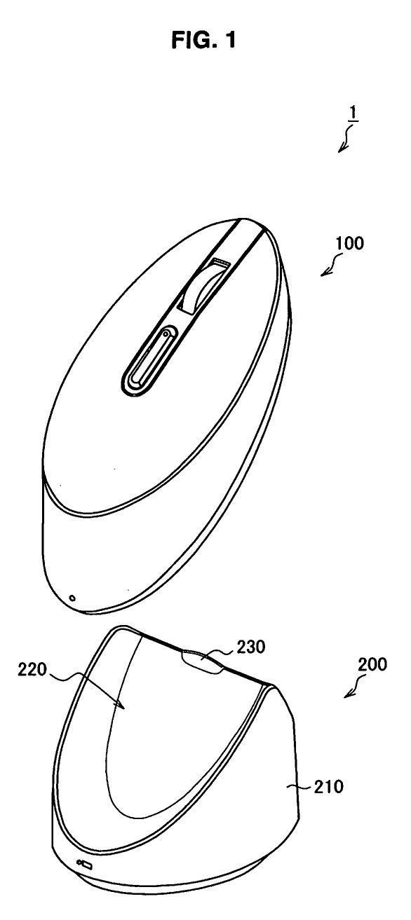

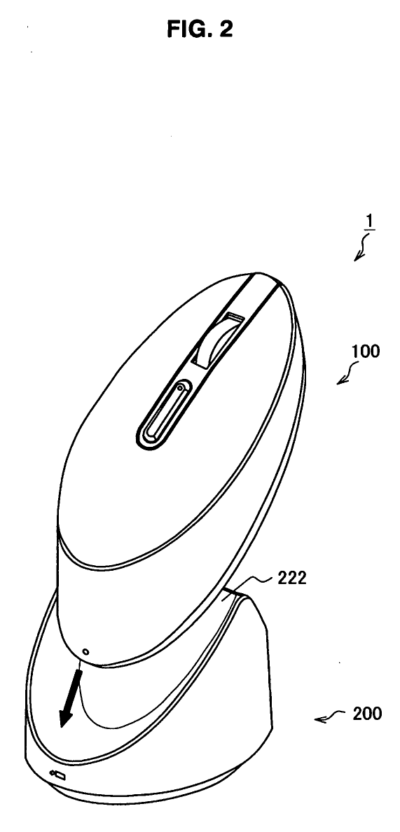

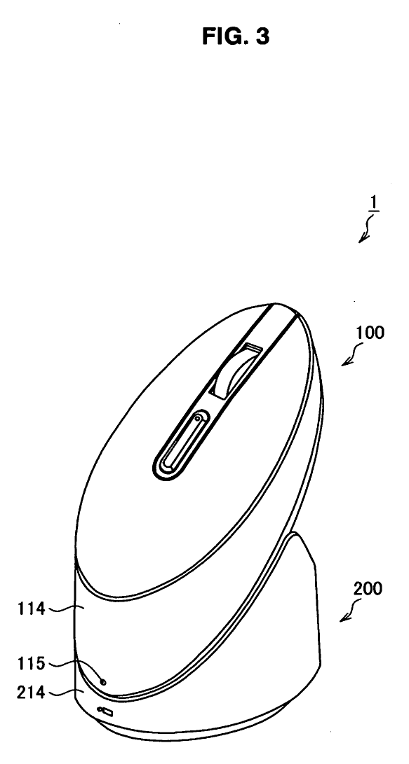

First, an outline structure of a mouse unit 1 according to an embodiment of the present invention will be explained with reference to FIG. 1 to FIG. 3. Note that FIG. 1 is a perspective view showing the mouse unit 1 according to the present embodiment in a disengaged state. FIG. 2 is a perspective view showing the mouse unit 1 according to the present embodiment in a state in which a mouse 100 is being caused to be held by a cradle 200. FIG. 3 is a perspective view showing the mouse unit 1 according to the present embodiment in a state in which the mouse 100 is set in the cradle 200.

As shown in FIG. 1 to FIG. 3, the mouse unit 1 according to the present embodiment includes the mouse 100 and the cradle 200 that holds the mouse 100. The mouse 100 according to the present embodiment is an optical wireless mouse, and as shown in FIG. 1, it is disengaged from the cradle 200 and used. Further, a rechargeable secondary battery is mounted in the mouse 100 and when the secondary battery is to be charged, the bottom of the mouse 100 is slid in a downward direction over an inclined surface of the cradle 200, as shown in FIG. 2, thus causing the mouse 100 to be held in a holding position shown in FIG. 3. The holding position is a position in which a back surface of a lower member of the mouse 100 and a holding portion 220 of the cradle 200 fit together and the reciprocally facing surfaces of the mouse 100 and the cradle 200 are in close contact.

The battery that is mounted in the mouse 100 according to the present embodiment is charged by non-contact charging. Non-contact charging is performed by non-contact transmission of electric power using electromagnetic induction between coils respectively mounted in the cradle 200 that is the transmission side and in the mouse 100 that is the reception side. As a result, metal terminals to electrically connect the mouse 100 and the cradle 200 in order to charge the battery are not needed, and thus the mouse 100 can be easily held in the cradle 200 and short circuits caused by dust or moisture etc. can also be prevented.

With the mouse unit 1 according to the present embodiment, the mouse 100 can easily be held by the cradle 200 and the mouse 100 can also be held in the cradle 200 in a stable manner. Hereinafter, the structure of the mouse 100 and the cradle 200 that form the mouse unit 1 will be explained.

### Structure of Mouse

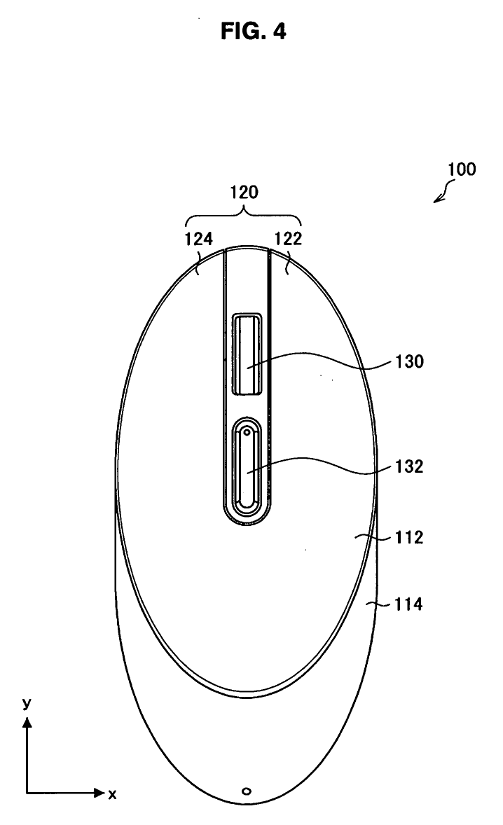

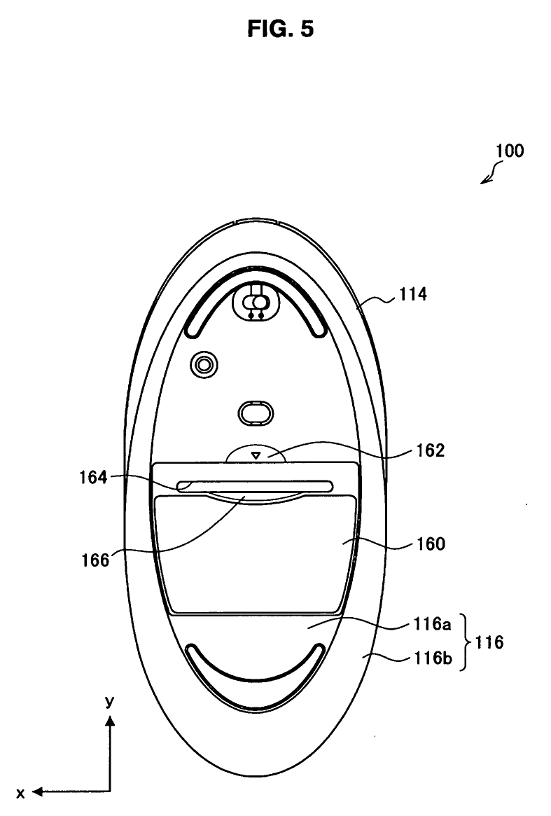

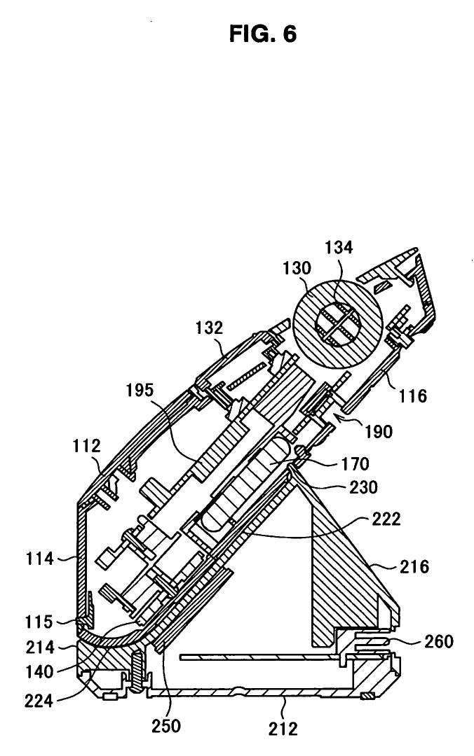

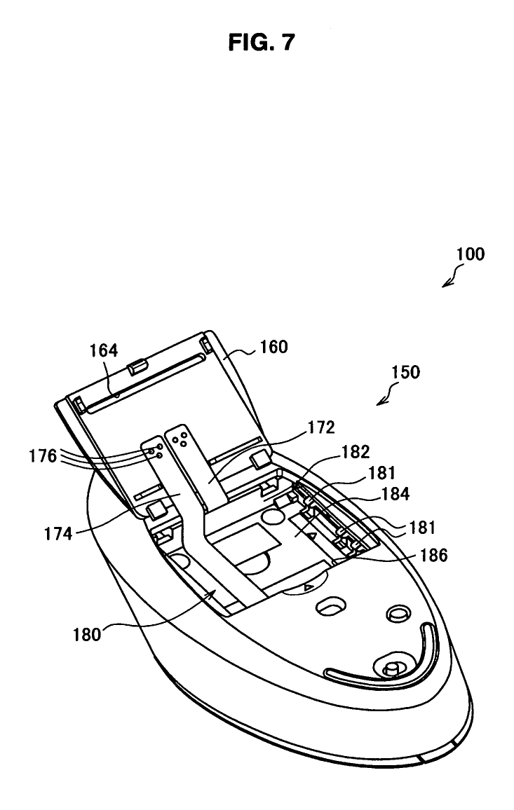

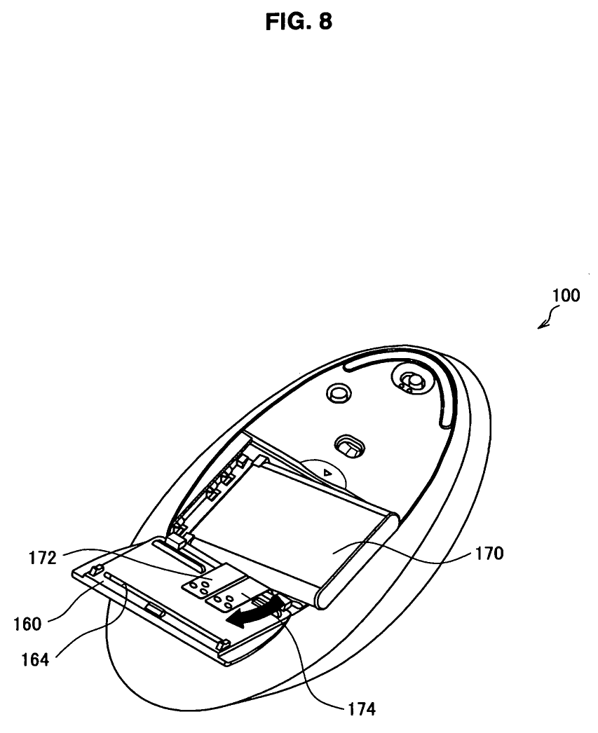

First, the structure of the mouse 100 according to the present embodiment will be explained with reference to FIG. 4 to FIG. 8. FIG. 4 is a plan view showing the mouse 100 according to the present embodiment. FIG. 5 is a bottom view showing the mouse 100 according to the present embodiment. FIG. 6 is a cross-section view showing a cross section of the mouse unit 1 shown in FIG. 3. FIG. 7 is a perspective view showing a battery cover 160 of the mouse 100 according to the present embodiment in an open state. FIG. 8 is a perspective view showing a state in which a battery 170 is being removed from the mouse 100 according to the present embodiment. Note that, in the explanation below, the front surface of the mouse 100 is the side in the positive direction of a y axis in FIG. 4, while the back surface of the mouse 100 is the side in the negative direction of the y axis.

The mouse 100 according to the present embodiment includes a housing 110, click buttons 120, a wheel 130, a secondary coil 140, a battery portion 150 and a position detection portion 190. The housing 110 includes a flat-shaped bottom, and a three-dimensional portion that is formed three-dimensionally such that a hand can be easily placed thereon.

As shown in FIG. 4 and FIG. 5, the housing 110 is formed of an upper member 112, a side member 114 and a lower member 116. The upper member 112 is a generally elliptical member that curves slightly towards the outside of the housing 110. The upper member 112 is provided integrally with the click buttons 120, and the wheel 130 and an operation button 132 to perform operation of a browser and an application etc. are provided between the click buttons 120. The side member 114 is a member that couples the upper member 112 and the lower member 116 and has a general ring shape that inclines towards the front surface of the mouse 100. As shown in FIG. 3, the back surface of the side member 114 is formed such that, when the mouse 100 is held in the cradle 200, the back surface of the side member 114 is generally flush with an upper surface of the cradle 200. In addition, a charger lamp 115 that indicates a state of charge of the battery 170 of the mouse 100 is provided in the back surface of the side member 114.

The lower member 116 includes a generally elliptical flat bottom surface portion 116a and a curved surface portion 116b that is formed as a convex curved surface from the edge of the bottom surface portion 116a. The bottom surface portion 116a is in contact with a placement surface on which the mouse 100 is placed when operating the mouse 100. The battery cover 160 is provided in the bottom surface portion 116a such that it is generally flush with the bottom surface portion 116a. With the upper member 112 and the side member 114, the curved surface portion 116b realizes a three-dimensional shape of the mouse 100. By providing the curved surface portion 116b, the mouse 100 can be stably held by the holding portion 220 of the cradle 200.

The click buttons 120 are provided on the front surface of the upper member 112 and are formed of a right click button 122 that is provided on the right side, and a left click button 124 that is provided on the left side. When the right click button 122 or the left click button 124 is depressed by a user in the direction of the z axis and thus clicked, a click detection portion (not shown in the figures) detects the click, and outputs a click signal indicating that a click has been performed. Depending on the method of depressing the right click button 122 and the left click button 124, functions can be performed, such as, for example, a function to display a menu relating to a position indicated by a mouse pointer, or a function to operate selection or determination applications and so on.

The wheel 130 is a ring-shaped member provided in the center of the front surface of the upper member 112 such that it is sandwiched between the right click button 122 and the left click button 124. The wheel 130 is rotatably supported by a support shaft 134 that extends internally in the housing 110 in the direction of the x axis, and a part of the wheel 130 is exposed on the outside of the upper member 112. When the user rotates the wheel 130 with a finger, the rotation of the wheel 130 is detected by a rotation detection portion (not shown in the figures), and a rotation signal is output that indicates the direction of rotation and the speed of rotation of the wheel 130. In addition, the wheel 130 can be structured such that it can be depressed in the direction of the z axis, and in this way, clicking operations can also be performed by the wheel 130. The detected signals are transmitted to a control portion (not shown in the figures) that is mounted on a board 195, and the control portion transmits the signals to a reception device adapted to receive these signals via an antenna (not shown in the figures).

The secondary coil 140 is a coil that generates voltage to charge the battery 170. As shown in FIG. 6, the secondary coil 140 is provided on the back surface of the lower member 116 of the housing 110. When the secondary coil 140 is caused to face a primary coil 250 provided in the cradle 200 and passes an electric current to the primary coil 250, an electromotive force is developed by electromagnetic induction. The battery 170 can be charged using the voltage generated. After the generated voltage has been stabilized through a rectification circuit or the like, it is transmitted to the battery 170 that is electrically connected.

The battery portion 150 houses the battery 170 that supplies the electricity necessary to cause the mouse 100 to function. The battery portion 150 is provided in a central portion of the lower member 116 inside the housing 110, and includes, as shown in FIG. 7, for example, the battery cover 160, the battery 170 and a battery housing portion 180.

The battery cover 160 is a cover that covers the battery housing portion 180 and is provided such that when it is fitted to the main body of the mouse 100, it is generally flush with the bottom surface of the mouse 100. As shown in FIG. 5, an indentation 162 is provided in the bottom surface portion 116a of the mouse 100 to allow easy opening of the battery cover 160. Additionally, a slit 164 that extends in the direction of the x axis is formed in the battery cover 160. When the battery cover 160 is opened, the user pulls up the battery cover 160 in the direction of opening while pushing the battery cover 160 in the negative direction of the y axis along the indentation 162. At that time, by providing the slit 164, the battery cover 160 can be caused to flex by the force of pushing the battery cover 160 in the negative direction of the y axis. In this way, the battery cover 160 can be easily opened.

Further, the slit 164 engages with a hook portion 230 of the cradle 200 and thus functions as a latch that causes the mouse 100 to latch onto the cradle 200. An inclined guiding surface 166 may be provided on the long side of the slit 164 on the side of the back surface of the mouse 100 such that the slit 164 engages easily with the hook portion 230 of the cradle 200. The inclined guiding surface 166 inclines gradually from the side of the battery cover 160 towards a center section of the long side of the slit 164, and from the side of the outer surface of the battery cover 160 towards the inner surface. In this way, the hook portion 230 of the cradle 200 is guided to the slit 164 by the inclined guiding surface 166.

In addition, by forming the slit 164 such that it extends in the direction of the x axis that generally orthogonally intersects with the slide direction when the mouse 100 is slotted into the cradle 200, it can be made difficult for the engagement between the slit 164 and the hook portion 230 of the cradle 200 to become disengaged. In terms of position, it is preferable for the slit 164 to be formed at the front of the battery cover 160. In this way, when the mouse 100 is latched onto the hook portion 230 of the cradle 200, the battery 170 of the mouse 100 is in a position below the hook portion 230, and the center of gravity is stable. As a result, the mouse 100 can be held stably by the cradle 200.

As shown in FIG. 7, when the battery cover 160 is opened, the battery housing portion 180 that houses the battery 170 is revealed. The battery 170 according to the present embodiment is a rechargeable secondary battery, and a lithium ion secondary battery, for example, can be used. The battery 170 has a generally rectangular shape, and is provided with a terminal portion (not shown in the figures) that comes into contact with a metal terminal 181 provided on one side surface of the battery housing portion 180. The battery housing portion 180 that houses the battery 170 is formed as an indented section with a shape corresponding to the shape of the battery 170 that is inserted (when a plurality of batteries are housed, it has a shape corresponding to the arrangement of the batteries when they are housed). On an internal surface on one side of the battery housing portion 180 that is generally parallel to the direction of the y axis, the battery housing portion 180 is provided with the metal terminal 181 that connects with the terminal portion of the battery 170 when the battery 170 is inserted into the battery housing portion 180.

As shown in FIG. 7, the battery portion 150 according to the present embodiment is provided with two tags that connect the battery cover 160 and the battery housing portion 180. One of the tags is a battery cover tag 172 that prevents the possibility of loss of the battery cover 160 by the battery cover 160 becoming completely detached from the battery housing portion 180. The other tag is a removal tag 174 that allows the battery 170 inserted in the battery housing portion 180 to be removed with ease.

The battery cover tag 172 connects the internal surface of the battery cover 160 and an internal surface 182 of the back surface (the side in the negative direction of the y axis) of the mouse 100 in the battery housing portion 180. The battery cover tag 172 and the battery cover 160 can be fixed together by welding. The battery cover tag 172 can be formed of, for example, a flexible film member, and is formed at a length that allows play for the battery cover 160 to be moved freely when the battery cover 160 is removed from the main body of the mouse 100.

On the other hand, the removal tag 174 connects the internal surface of the battery cover 160 and an internal surface 186 of the front surface (the side in the positive direction of the y axis) of the mouse 100 in the battery housing portion 180. In other words, one end of the removal tag 174 is connected to the reverse surface of the battery cover 160, and after extending along the internal surface 182 to which the battery cover tag 172 is attached and along a bottom surface 184 of the battery housing portion 180, another end of the removal tag 174 is attached to the internal wall 186 that faces the internal surface 182. The removal tag 174 is bent such that it follows the internal surfaces of the battery housing portion 180. The removal tag 174 and the battery cover 160 can be fixed together by welding. The removal tag 174 can be formed of, for example, a flexible film member, and is provided such that it is generally parallel to the battery cover tag 172. In this way, when the battery cover 160 is opened, the battery cover 160 can be prevented from inclining in either the left or right directions (along the x axis).

The battery 170 is inserted into the battery housing portion 180 such that the battery 170 is placed on top of the removal tag 174. Here, if the battery 170 is mistakenly inserted into the battery housing portion 180 without being placed on top of the removal tag 174, it becomes difficult to remove the battery 170 from the battery housing portion 180. In this case, if it is attempted to remove the battery 170 in this state from the battery housing portion 180 using a screwdriver, tweezers or the like, there is a risk of damaging the battery 170. In the present embodiment, by connecting the other end of the removal tag 174 to the internal surface 186 facing the internal surface 182 of the battery housing portion 180 to which the other end of the battery cover tag 172 is attached, the structure allows the battery 170 to be placed on top of the removal tag 174. In this way, faulty insertion of the battery 170 into the battery housing portion 180 can be prevented.

Then, when removing the battery 170 from the battery housing portion 180, as shown in FIG. 8, the battery cover 160 is opened and the removal tag 174 or the battery cover 160 is raised or twisted in the direction of the arrow. In this way, the battery 170 lifts out of the battery housing portion 180 and the battery 170 can be easily removed from the battery housing portion 180.

As shown in FIG. 6, the position detection portion 190 is provided between the wheel 130 on the front surface side and the battery 170 on the back surface side. The position detection portion 190 detects the position, the movement distance, the direction of movement and the speed of movement of the mouse 100. The position detection portion 190 includes a light emitting portion (not shown in the figures) that emits light onto the placement surface on which the mouse 100 is placed, and a light receiving portion (not shown in the figures) that receives reflected light that is reflected back from the light emitted by the light emitting portion. The position detection portion 190 transmits detected positional information to the control portion (not shown in the figures) mounted on the board 195, and the control portion transmits the positional information via the antenna (not shown in the figures) to the reception device adapted to receive information such as the positional information etc.

### Structure of Cradle

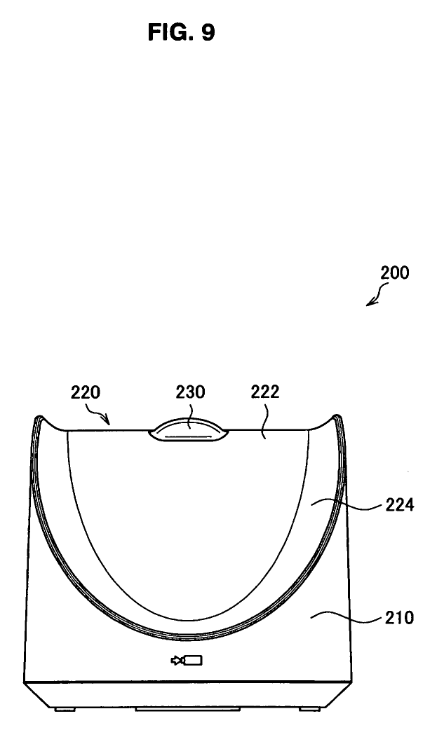

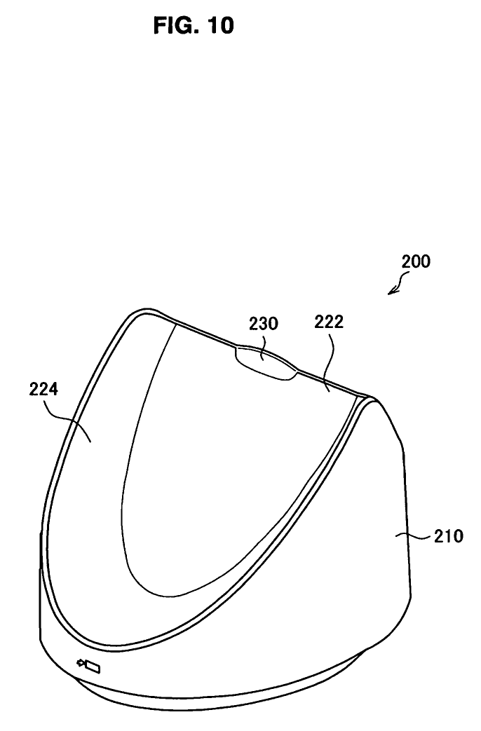

Next, the structure of the cradle 200 according to the present embodiment will be explained with reference to FIG. 6, FIG. 9 and FIG. 10. FIG. 9 is a front view showing the cradle 200 according to the present embodiment. FIG. 10 is a perspective view showing the cradle 200 according to the present embodiment.

The cradle 200 according to the present embodiment holds the above-described mouse 100 and charges the battery 170 housed in the mouse 100. As shown in FIG. 9 and FIG. 10, the cradle 200 includes a support portion 210, and the holding portion 220 that is formed as a depression in the support portion 210.

The support portion 210 is a base that supports the mouse 100 held by the holding portion 220, and the holding portion 220 is formed on the upper side of a generally cylindrical shape.

The holding portion 220 is a portion that holds the mouse 100 and is formed as a depression in a shape corresponding to the shape of the back surface of the lower member 116 of the mouse 100. In the present embodiment, as shown in FIG. 9, the holding portion 220 is formed such that an outer edge, when seen in the front view, has a generally U-shaped form.

The holding portion 220 includes an inclined surface 222 and a guiding edge portion 224. The inclined surface 222 is a flat surface that has a predetermined angle with respect to a bottom surface 240 of the support portion 210. The inclined surface 222 faces a part (the back surface side) of the bottom surface of the mouse 100 that is supported by the cradle 200. The guiding edge portion 224 is provided on side portions and a lower portion of the outer edge of the inclined surface 222, and is provided such that it is in close contact with and covers the back surface of the lower member 116 of the mouse 100 held by the holding portion 220. The guiding edge portion 224, for example, can be formed as a general U shape that follows the outer edge of the inclined surface 222. Additionally, the guiding edge portion 224 is formed such that it has a curved surface in the upward direction (in the direction towards the outside of the housing 110 with respect to the inclined surface 222) from the edge on the side of the inclined surface 222, curving continuously and concavely from the inclined surface 222. By being formed in this shape, the guiding edge portion 224 guides the mouse 100 to its holding position when it is slid along the inclined surface 222.

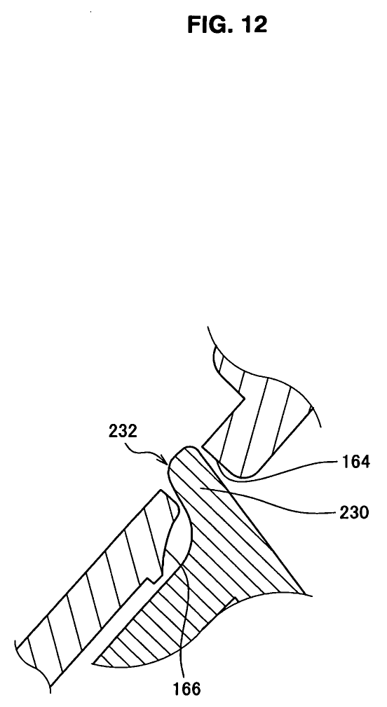

The hook portion 230 is provided on the upper side of the outer edge of the holding portion 220, protruding from the inclined surface 222. The hook portion 230 is a member to latch the mouse 100, and has a generally semi-circular shape, as shown in FIG. 9. Note that the shape of the hook portion 230 is not limited to this example, and may be, for example, a generally triangular shape or a generally square shape. The outer edge of the hook portion 230 is formed as a rounded and generally R shape (refer to FIG. 12), such that it easily engages with the slit 164 of the mouse 100.

As shown in FIG. 6, an inner portion of the cradle 200 includes the primary coil 250 for charging the battery 170 of the mouse 100 and a power source connection terminal 260 that is connects to an external power source. The primary coil 250 is provided such that, when the mouse 100 is held by the holding portion 220, the primary coil 250 faces the secondary coil 140 provided in the mouse 100. When an electric current is input via the power source connection terminal 260 that is connected to the external power source, the electrical current flows into the primary coil 250 and a magnetic field is generated. Power can be generated in the secondary coil 140 of the mouse 100 by the flow of this magnetic force.

Furthermore, a second inclined surface 216 is provided in the support portion 210 of the cradle 200 such that it intersects with the inclined surface 222 of the holding portion 220. The second inclined surface 216 is a flat surface that is formed, for example, extending in the same direction as the direction of protrusion of the hook portion 230. By forming the second inclined surface 216, it is possible to move the front surface of the mouse 100 in the held state forwards and backwards, with the hook portion 230 as the fulcrum. In this way, the mouse 100 can be easily held in the cradle 200.

The structures of the mouse 100 and the cradle 200 according to the present embodiment are explained above. As described above, with the mouse unit 1 that is formed of this type of mouse 100 and cradle 200, the mouse 100 can be easily held in the cradle 200. As a result, the mouse 100 can easily be set in a state to charge the battery 170. Hereinafter, the relationship between the mouse 100 and the cradle 200 of the mouse unit 1 according to the present embodiment will be explained.

### Setting Mouse in Holding Position

With the mouse unit 1 according to the present embodiment, the mouse 100 can be easily held in the cradle 200. This is because the shape of the holding portion 220 guides the mouse 100 to the holding position, and the slit 164 of the mouse 100 engages naturally with the hook portion 230 of the cradle 200.

As shown in FIG. 10, the holding portion 220 of the cradle 200 according to the present embodiment includes the flat inclined surface 222 and the curved guiding edge portion 224. The guiding edge portion 224 according to the present embodiment is formed as a generally U-shaped curved surface. For that reason, as shown in FIG. 1 to FIG. 3, when the mouse 100 is moved in the downward direction (in the negative direction of the z axis) in line with the inclined surface 222, when a part of the lower member 116 of the mouse 100 comes into contact with the guiding edge portion 224, the mouse 100 is guided along the curved surface of the guiding edge portion 224 to the holding position. In other words, if the mouse 100 is positioned such that the bottom surface portion 116a of the mouse 100 approximately faces the inclined surface 222 of the cradle 200, the mouse 100 can be moved to the holding position by the concave curved surface that extends from the outer edge of the guiding edge portion 224 to the inclined surface 222, without positioning the mouse 100 in a specific position. Then, when the mouse 100 is moved to the holding position, the back surface of the lower member 116 of the mouse 100 engages with the holding portion 220 of the cradle 200 such that the mouse 100 is held in close contact.

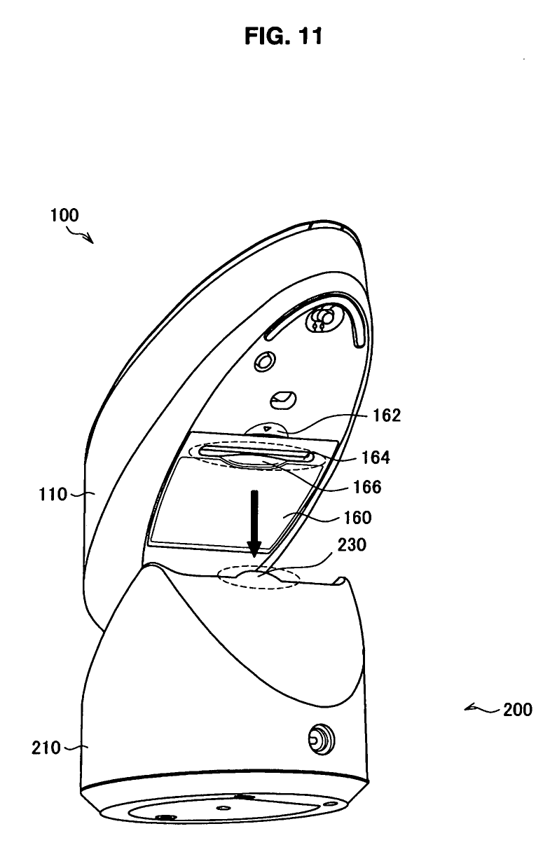

At that time, as shown in FIG. 11 and FIG. 12, the slit 164 of the mouse 100 and the hook portion 230 of the cradle 200 engage with each other, and the mouse 100 is thus latched onto the cradle 200. Here, the inclined guiding surface 166 is formed on the slit 164 of the mouse 100 and guides the hook portion 230 such that it engages with the slit 164. As a result, when the mouse 100 is slid over the inclined surface 222 and approaches the holding position, the hook portion 230 is in contact with the inclined guiding surface 166 of the mouse 100, and the hook portion 230 is guided to the slit 164 along the shape of the inclined guiding surface 166. Then, when the mouse 100 is positioned in the holding position of the cradle 200 and is held in close contact with the holding portion 220, the slit 164 of the mouse 100 and the hook portion 230 of the cradle 200 engage with each other and the mouse 100 is latched onto the cradle 200.

In this way, when the mouse 100 is held in the cradle 200, the back surface of the lower member 116 of the mouse 100 fits with the holding portion 220 of the cradle 200, as shown in FIG. 3. In other words, the bottom surface 116a of the mouse 100 and the inclined surface 222 of the cradle 200 face each other in close contact, while the curved surface 116b of the lower member 116 of the mouse 100 and the guiding edge portion 224 of the cradle 200 face each other in close contact. Accordingly, the mouse 100 is latched onto the cradle 200 in a state in which the back surface of the mouse 100 is in a state of close contact with the holding portion 220 of the cradle 200. At this time, the primary coil 250 of the cradle 200 and the secondary coil 140 of the mouse 100 are facing each other. Consequently, the electromotive force generated in the secondary coil 140 by the magnetic force arising when an electrical current is conducted to the primary coil 250 can be increased, thus improving charging efficiency of the battery 170.

Note that, to allow the mouse 100 to be easily held by the cradle 200, the inclined surface 222 of the cradle 200 is provided such that it has a predetermined angle θ with respect to a bottom surface 212 of the cradle 200. The angle θ is determined taking into account the fit between the inclined surface 222 and the bottom surface of the mouse 100, and an angle that allows foreign material on the inclined surface 222 to slide off and so on. The predetermined angle θ is set, for example, in a range between 45 degrees and 60 degrees, and can be set, for example, as approximately 48.4 degrees.

If the angle θ is set to a greater angle than the above-described range, it becomes difficult to cause the mouse 100 to be held by the cradle 200. Further, the height of the mouse 100 when it is held by the cradle 200 becomes high, thus resulting in an unstable state and it becomes difficult to cause the mouse 100 to be held in a stable manner. Furthermore, the center of gravity of the mouse 100 moves to the rearward side (the side of the upper member 112 of the mouse 100 in FIG. 3), and the fit between the bottom surface 116a of the mouse 100 and the inclined surface 222 of the cradle 200 deteriorates. As a result, charging efficiency of the battery 170 deteriorates. On the other hand, if the angle θ is set to a smaller angle than the above-described range, it also becomes difficult to cause the mouse 100 to be held by the cradle 200. As described later, it is difficult to remove from the holding portion 220 a foreign material 5 that is placed on the inclined surface 222 of the cradle 200. It is preferable for the angle θ of the inclined surface 222 to be set within the above-described range.

In addition, with the mouse unit 1 according to the present embodiment, when the mouse 100 is set in the cradle 200 in the holding position as shown in FIG. 3, the back surface of the side member 114 of the mouse 100 and the front surface 214 of the support portion 210 of the cradle 200 are generally flush in the generally perpendicular direction with respect to the bottom surface 212 of the cradle 200. In other words, they are set such that they have an angle of 90 degrees with respect to the bottom surface 212 of the cradle 200. Here, the inclination of the side member 114 of the mouse 100 and the angle of the support portion 210 of the cradle 200 are fixed such that the above-described surfaces have a generally perpendicular angle with respect to the bottom surface 212 of the cradle 200. By adopting this shape, the user can easily verify the charger lamp 115 that is provided in the back surface of the side member 114 of the mouse 100.

Additionally, with the mouse unit 1 according to the present embodiment, to cause the mouse 100 to be held by the cradle 200, the mouse 100 is slide over the inclined surface 222 of the cradle 200. When this movement is performed, the hook portion 230 is hidden by the mouse 100 and it is difficult for user to observe it. However, as described above, as the guiding edge portion 224 of the cradle 200 guides the mouse 100 to the holding position, the user can easily cause the mouse 100 to latch onto the cradle 200, even if the position of the hook portion 230 cannot be visually verified. By forming the outer edge of the hook portion 230 as a general R shape to have a shape that conforms with the slit 164 of the mouse 100, and also by forming the inclined guiding surface 166 that guides the hook portion 230 to the slit 164, the mouse 100 can be latched onto the cradle 200 even more easily. Then, as shown in FIG. 3, a latching member (in the present embodiment, the hook portion 230) that causes the mouse 100 to latch onto the cradle 200 can be provided such that it is not apparently visible from the mouse unit 1 when the mouse 100 is held by the cradle 200. In this way, the mouse unit 1 can be structured as a visually appealing shape with a high level of design.

Removal of Foreign Material from Holding Position

The cradle 200 according to the present embodiment charges the battery 170 of the mouse 100 by non-contact charging. For that purpose, the cradle 200 is provided with the primary coil 250 that generates a magnetic field to charge the battery 170, the primary coil 250 being provided on an internal surface in a lower portion of the inclined surface 222. When an electric current that is fed from an external power source is passed through the primary coil 250, if foreign material formed of metal, such as a clip or coin etc. is placed on the inclined surface 222 in the position of the primary coil 250, the foreign material becomes charged and could generate heat. Here, the cradle 200 according to the present embodiment is formed in a shape such that foreign material is removed from the holding portion 220.

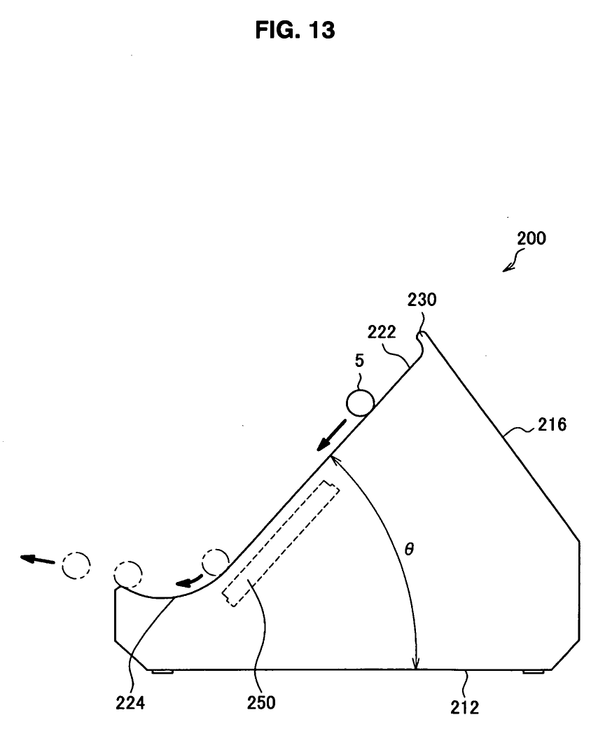

FIG. 13 is an explanatory diagram illustrating the shape of the inclined surface 222 and the guiding edge portion 224. As shown in FIG. 13, the holding portion 220 of the cradle 200 is formed of the flat inclined surface 222 and the curved guiding edge portion 224. The inclined surface 222 is arranged such that it has the predetermined angle θ with respect to the bottom surface 212. As described above, the angle θ is decided taking into account the ease of latching the mouse 100 onto the cradle 200, the degree of fit between the inclined surface 222 and the bottom surface of the mouse 100, and is also decided such that the foreign material 5 placed on the inclined surface 222 will slide and fall off. Further, the guiding edge portion 224 according to the present embodiment has a concavely curved surface. If the curvature is too great, the foreign material 5 is trapped in the indentation of the curved surface. Consequently, the guiding edge portion 224 is formed as a curved surface having a small curvature such that the foreign material 5 placed on the inclined surface 222 definitely slips and falls off.

The foreign material 5 placed on the inclined surface 222 slips and falls in the direction of gravity along the inclined surface 222. It further slides on the curved surface of the guiding edge portion 224 that continues from the inclined surface 222 and is thus removed from the holding portion 220. In this way, the foreign material 5 is removed from an area in which it could be affected by the magnetic field generated by the primary coil 250 of the cradle 200, thus preventing the foreign material 5 from generating heat as a result of magnetic force.

The mouse unit 1 according to the present embodiment is explained above. According to the above-described mouse unit 1, the holding portion 220 is formed on the cradle 200, the holding portion 220 being formed of the inclined surface 222 that has a predetermined angle of inclination, and of the guiding edge portion 224 that is provided on the side portions of the outer edge and the lower portion of the inclined surface 222. As a result, to hold the mouse 100 in the cradle 200, when the mouse 100 is caused to slide along the inclined surface 222, the mouse 100 is guided to the guiding edge portion 224 and moved to the holding position. In this way, the mouse 100 can easily be held in the cradle 200. Furthermore, due to the inclined surface 222 of the cradle 200, the mouse 100 can easily be latched onto the cradle 200 and the inclined surface 222 and the bottom surface of the mouse 100 are brought into close contact, thus improving the charging efficiency. Moreover, the foreign material 5 that can become energized can be removed from the holding portion 220.

In addition, the hook portion 230 is provided on the upper portion of the outer edge of the inclined surface 222 of the cradle 200. The hook portion 230 engages with the slit 164 of the mouse 100 when the mouse 100 is in the holding position. In this way, when the mouse 100 is held by the holding portion 220 of the cradle 200, the mouse 100 is latched onto the cradle 200. Thus the holding position of the mouse 100 can be stably maintained and the mouse 100 can be prevented from falling from the cradle 200.

Moreover, as the back surface of the lower member 116 of the mouse 100 is held closely by the holding portion 220 of the cradle 200, the mouse 100 can be held in a stable manner. In addition, in this state, the secondary coil 140 that generates the voltage necessary to charge the battery 170 of the mouse 100, and the primary coil 250 of the cradle 200 face each other. In this way, the charging efficiency of the battery 170 can be improved.

It should be understood by those skilled in the art that various modifications, combinations, sub-combinations and alterations may occur depending on design requirements and other factors insofar as they are within the scope of the appended claims or the equivalents thereof.

In the present embodiment, the hook portion 230 is provided as a latching member to latch the mouse 100 onto the cradle 200, but the present invention is not limited to this example. For example, a section of the guiding edge portion 224 of the cradle 200 may be further extended in the upward direction, and a supporting member may be provided that supports the side member 114 of the mouse 100 when the mouse 100 is fitted with the cradle 200.

The present application contains subject matter related to that disclosed in Japanese Priority Patent Application JP 2008-229566 filed in the Japan Patent Office on Sep. 8, 2008, the entire content of which is hereby incorporated by reference.

What is claimed is:

1. A cradle, comprising:
a support portion; and
a holding portion that is formed on the support portion as a depression with a shape corresponding to part of a mouse; wherein
the holding portion includes
an inclined surface that is a flat surface over which a mouse can be slid and that has a predetermined angle with respect to a bottom surface of the support portion, and
a guiding edge portion that is formed on at least a lower portion and a side portion of an outer edge of the inclined surface and that guides a mouse that is slid along the inclined surface to a holding position.

2. The cradle according to claim 1, wherein
the guiding edge portion is formed in a shape that removes foreign material that is placed on the inclined surface from the holding position.

3. The cradle according to claim 2, wherein
the guiding edge portion is formed as a generally U shape along the outer edge of the inclined surface and is formed having a concavely curved surface in an upward direction from an outer edge of the inclined surface.

4. The cradle according to claim 1, wherein
the holding portion includes a hook portion, provided on an upper portion of the outer edge of the inclined surface, that latches a mouse in the holding position.

5. The cradle according to claim 4, wherein
the hook portion is a protrusion that protrudes from the inclined surface and an outer edge of the hook portion is formed as a general R shape.

6. The cradle according to claim 1, wherein
a primary coil that causes generation of a magnetic force to perform non-contact charging of a mouse is provided inside the cradle in a position facing the inclined surface.

7. The cradle according to claim 1, wherein
the predetermined angle is between 45 degrees and 60 degrees.

8. A mouse, comprising:
a housing that includes
a lower member formed of a bottom surface and a curved surface that is formed on an outer edge of the bottom surface,
an upper member provided with an operating portion that is used to perform an input operation, and
a side member that couples the lower member and the upper member; and
a detection portion, provided inside the housing, that detects a position and operation of the mouse itself; wherein
a slit that engages with a hook portion of a cradle holding the mouse is formed in a bottom surface of the housing.

9. The mouse according to claim 8, wherein
an inclined guiding surface that guides the mouse to the hook portion of the cradle is formed on the slit.

10. The mouse according to claim 9, wherein
the slit is provided in a battery cover that covers a battery housing portion housing a battery supplying electric power and that is openable/closable with respect to the housing.

11. A mouse unit, comprising:
a mouse and a cradle that holds the mouse; wherein
the mouse includes a housing including
a lower member that is formed of a bottom surface and a curved surface formed on an outer edge of the bottom surface, part of the lower member fitting with a support portion of the cradle,
an upper member provided with an operating portion that is used to perform an input operation, and
a side member that couples the lower member and the upper member, and
the cradle includes
a support portion, and
a holding portion that is formed on the support portion as a depression with a shape corresponding to part of the mouse, wherein
the holding portion includes
an inclined surface that is a flat surface over which the mouse can be slid and that has a predetermined angle with respect to a bottom surface of the support portion, and
a guiding edge portion that is formed on at least a lower portion and a side portion of an outer edge of the inclined surface and that guides the mouse that is slid along the inclined surface to a holding position.

12. The mouse unit according to claim 11, wherein
the holding portion of the cradle includes a hook portion, provided on an upper portion of the outer edge of the inclined surface, that latches the mouse in the holding position, and
a slit that engages with the hook portion of the cradle in the holding position is formed in a bottom surface of the housing of the mouse.

13. The mouse unit according to claim 11, wherein
a primary coil that causes generation of a magnetic force to perform non-contact charging of the mouse is provided inside the cradle in a position facing the inclined surface,
a secondary coil that generates an electric current by the magnetic force generated by the primary coil of the cradle is provided inside the housing of the mouse such that the secondary coil faces the bottom surface, and
when the mouse is being held by the cradle in the holding position, the primary coil of the cradle and the secondary coil of the mouse face each other.

14. The mouse unit according to claim 11, wherein
when the mouse is being held by the cradle in the holding position, a surface on a back surface side of the side member of the mouse and a surface on a front surface side of the support member of the cradle are generally perpendicular to the bottom surface of the cradle and are generally flush with each other.
